(19) United States
(12) Patent Application Publication
(10) Pub. No.: US 2018/0103584 A1
(43) Pub. Date: Apr. 19, 2018

(54) ADJUSTABLE ONE HANDED STRING TRIMMER

(71) Applicant: Mark Orton, Mimbres, NM (US)

(72) Inventor: Mark Orton, Mimbres, NM (US)

(21) Appl. No.: 15/707,134

(22) Filed: Sep. 18, 2017

Related U.S. Application Data
(60) Provisional application No. 62/408,406, filed on Oct. 14, 2016.

(51) Int. Cl. A01D 34/90; A01D 34/416

(52) U.S. Cl. CPC A01D 34/902; A01D 34/416

(57) ABSTRACT

A string trimmer includes a handle portion that includes an arm cuff for securing a portion of an arm of an operator to the handle portion, and a grip portion enabling the operator to hold the grip portion using a hand of the same arm during operation of the string trimmer. The string trimmer also includes a first shaft coupled to the handle portion, a second shaft at least partially slidable into the first shaft, and a head portion coupled to the second shaft. The head portion includes a hub comprising a cutting tool and a motor configured to rotate the hub.

### CROSS-REFERENCE TO RELATED APPLICATIONS

The present application claims priority to U.S. Provisional Patent Application Ser. No. 62/408,406, filed Oct. 14, 2016 entitled “Balanced One Hand String Trimmer”, the entire disclosure of which is hereby incorporated by reference.

### FIELD OF THE DISCLOSURE

The present disclosure relates generally to powered landscape maintenance tools, and more specifically, to an adjustable string trimmer.

### BACKGROUND

Conventional string trimmers include a rotatable hub that holds a string of nylon or other material. A motor rotates the hub and string, and the string cuts vegetation that it contacts during the rotation of the hub. The hub is mounted on a shaft, and a handle is provided for a user to hold to stabilize the string trimmer or to move the string trimmer into a desired cutting position. Typical string trimmers thus require two hands to operate: a first hand to hold the string trimmer itself and to turn the string trimmer on and off, and a second hand to hold the handle to stabilize the trimmer. The use of two hands during operation of the string trimmer may lead to fatigue of the user's arms, hands, and/or back.

In addition, the user is often forced to stoop down or otherwise employ an ergonomically inefficient posture when operating the string trimmer to ensure that the string trimmer is placed in the desired cutting position. As a result, further strain and fatigue may be imparted to the user during operation of the string trimmer.

The present disclosure is aimed at solving one or more of the problems identified above.

### SUMMARY

In one embodiment, a string trimmer includes a handle portion that includes an arm cuff for securing a portion of an arm of an operator to the handle portion, and a grip portion enabling the operator to hold the grip portion using a hand of the same arm during operation of the string trimmer. The string trimmer also includes a first shaft coupled to the handle portion, a second shaft at least partially slidable into the first shaft, and a head portion coupled to the second shaft. The head portion includes a hub comprising a cutting tool and a motor configured to rotate the hub.

### BRIEF DESCRIPTION OF THE DRAWINGS

Advantages of the present disclosure will be readily appreciated, as the same becomes better understood by reference to the following detailed description, when considered in connection with the accompanying drawings. Non-limiting and non-exhaustive embodiments of the present disclosure are described with reference to the following figures, wherein like numerals refer to like parts throughout the various views unless otherwise specified.

FIG. 1 is a perspective view of a string trimmer according to one embodiment.

FIG. 2 is a perspective view of the string trimmer shown in FIG. 1 with a battery removed.

FIG. 3 is a perspective view of the handle portion and grip portion of the string trimmer shown in FIG. 1.

FIG. 4 is a perspective view of the arm cuff of the string trimmer shown in FIG. 1.

FIG. 5 is a side view of the handle portion and grip portion of the string trimmer shown in FIG. 1 during operation by a first user.

FIG. 6 is a side view of the handle portion and grip portion of the string trimmer shown in FIG. 1 during operation by a second user.

FIG. 7 is a side view of the handle portion and grip portion of the string trimmer shown in FIG. 1.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an examples” means that a particular feature, structure or characteristic described in connection with the embodiment of example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Several (or different) elements discussed below, and/or claimed, are described as being “coupled”, “in communication with” or “configured to be in communication with”. This terminology is intended to be non-limiting, and where appropriate, be interpreted to include without limitation, wired and wireless communication using any one or a plurality of suitable protocols, as well as communication methods that are constantly maintained, are made on a periodic basis, and/or made or initiated on an as needed basis.

The present disclosure particularly describes an adjustable string trimmer that only requires one hand to use. The string trimmer includes a head portion that is coupled to a lower shaft, and the lower shaft is slidably coupled to an upper shaft. The upper shaft is coupled to a handle portion, and a grip portion is also coupled to the upper shaft. The grip portion is movable with respect to the upper shaft such that the user may adjust the location of the grip portion by moving the grip portion along the upper shaft until the grip portion reaches a desired location. The handle portion includes an adjustable arm cuff that is sized and shaped to securely attach to the user's forearm. The arm cuff is hinged or otherwise adjustable to enable the arm cuff to fit forearms of various sizes. In addition, the arm cuff is pivotable about at least one axis to enable the arm cuff to be moved toward or away from the grip portion, thus enabling the arm cuff and grip portion to accommodate forearms of various lengths. The string trimmer is also balanced about a center of gravity positioned substantially at the grip portion to enable the user to easily move the string trimmer during operation. Accordingly, the string trimmer is adjustable in various ways to enable the user to comfortably use the string trimmer while minimizing an amount of fatigue or discomfort that may otherwise arise during operation of conventional string trimmers.

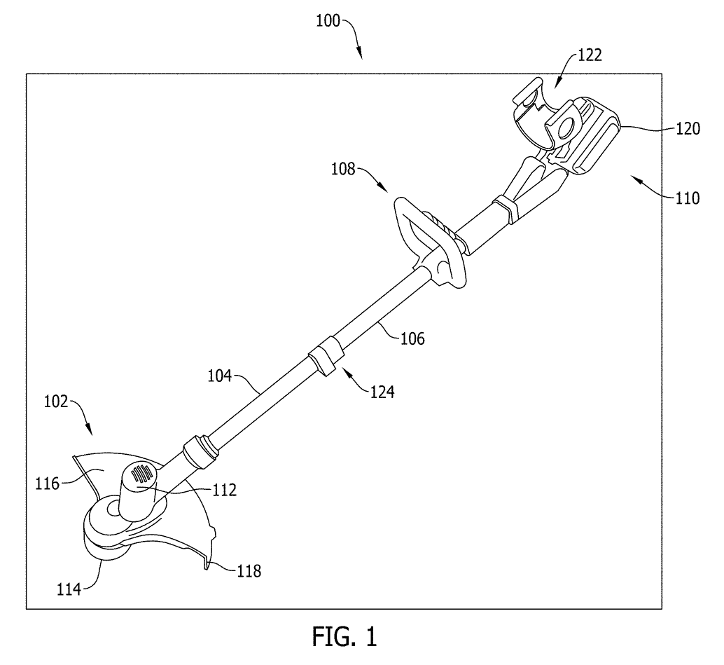

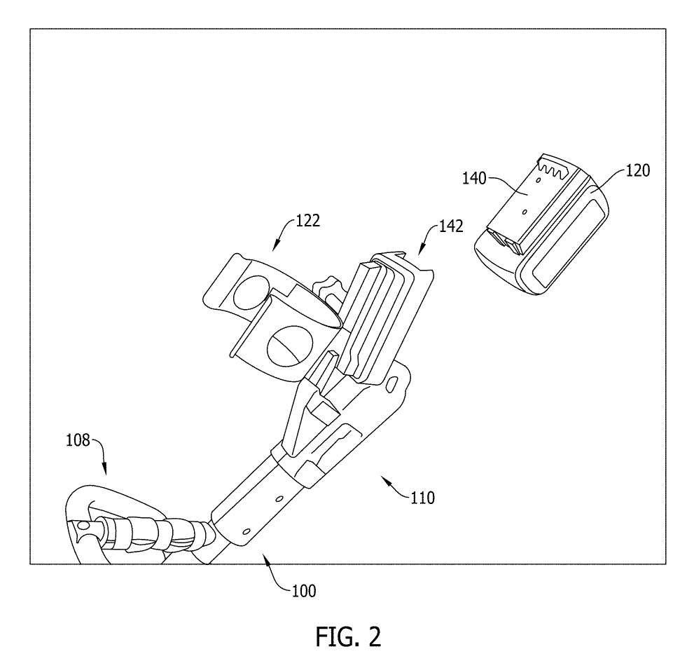

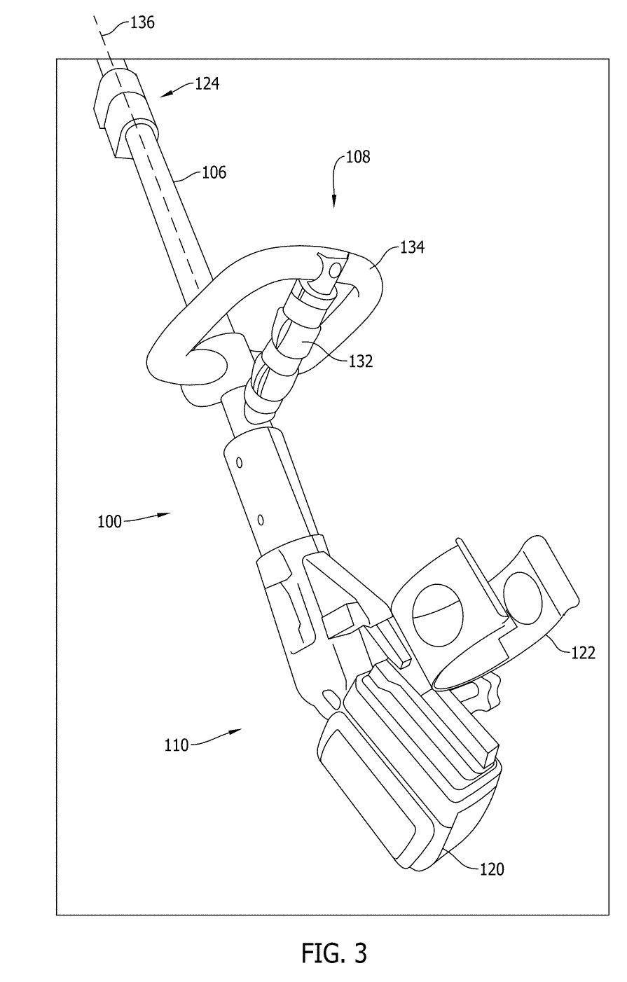

FIG. 1 is a perspective view of a string trimmer 100 according to one embodiment. The string trimmer 100 includes a head portion 102, a lower shaft 104 coupled to the head portion 102, an upper shaft 106 coupled to the lower shaft 104, a grip portion 108 coupled to the upper shaft 106, and a handle portion 110 coupled to the upper shaft 106. The head portion 102 includes a motor 112 and a hub 114 positioned within a housing 116, and a guard 118 formed within a portion of the housing 116. The handle portion 110 includes a removable battery 120 and an arm cuff 122. FIG. 2 illustrates the handle portion 110 of the string trimmer 100 with the battery 120 removed. FIG. 3 is a perspective view of the handle portion 110 and grip portion 108 of the string trimmer 100. Each of the above-identified components of the string trimmer 100 will be described in turn.

The motor 112 receives electrical power from a power cable (not shown) disposed within lower shaft 104 and upper shaft 106. In response to receiving electrical power, the motor 112 rotates the hub 114. In one embodiment, the motor 112 is enabled to rotate the hub 114 at a user-controlled speed, for example, by enabling the user to provide a user-controlled amount of electrical power to the motor 112 by depressing a power button by an adjustable amount. The motor 112 then rotates the hub 114 at a speed that is a function of the amount of electrical power transmitted to the motor 112.

The hub 114 includes a cutting tool (not shown) that is usable to cut grass, shrubs, or other suitable material. In one embodiment, the cutting tool includes a spool of wire that is rotated by the hub 114 at a speed sufficient to cut the material. The wire may be formed of nylon (either monofilament or reinforced with another material such as aluminum, or similar), a metal or metal allow, or any other suitable material that enables the string trimmer 100 to operate as described herein.

The motor 112 and hub 114 are at least partially positioned within the housing 116. The housing 116 may be formed of a plastic material (e.g., acrylonitrile butadiene styrene (ABS) plastic), a metal (e.g., aluminum) or metal alloy, or another suitable material. A guard 118 is formed in the housing 116 to reduce an amount of debris that might otherwise be projected back toward the operator during use.

The lower shaft 104 couples the head portion 102 to the upper shaft 106. The lower shaft 104 and the upper shaft 106 may be formed of a plastic material (e.g., ABS plastic), a metal (e.g., aluminum) or metal alloy, or another suitable material. The lower shaft 104 may be slidably coupled to the upper shaft 106 using a coupling mechanism 124. The coupling mechanism 124 may include, for example, a telescoping coupling or another suitable mechanism. For example, in one embodiment, a user may decrease the length of the string trimmer 100 by loosening the coupling mechanism 124, sliding the lower shaft 104 into the upper shaft 106 a desired amount, and then tightening the coupling mechanism 124 to prevent the lower shaft 104 from moving in relation to the upper shaft 106. Conversely, the user may increase the length of the string trimmer 100 by loosening the coupling mechanism 124, sliding the lower shaft 104 out of the upper shaft 106 a desired amount, and then tightening the coupling mechanism 124 to prevent the lower shaft 104 from moving in relation to the upper shaft 106. Thus, the user may conveniently adjust the length of the string trimmer 100 to more closely correspond to the user's height or preference. In addition, by adjusting the length of the string trimmer 100, the user may adjust the location of the center of gravity of the string trimmer 100 to enable the user to balance the weight of the string trimmer 100 about any suitable location of the string trimmer 100.

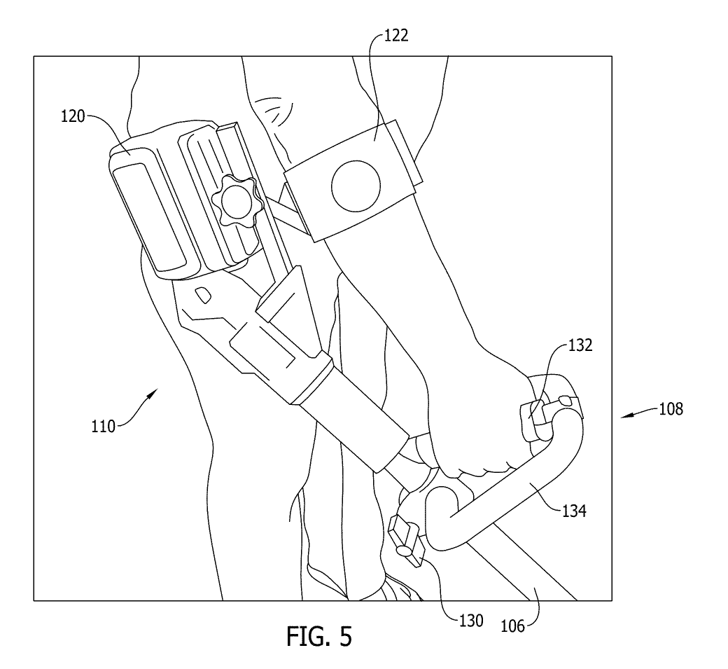

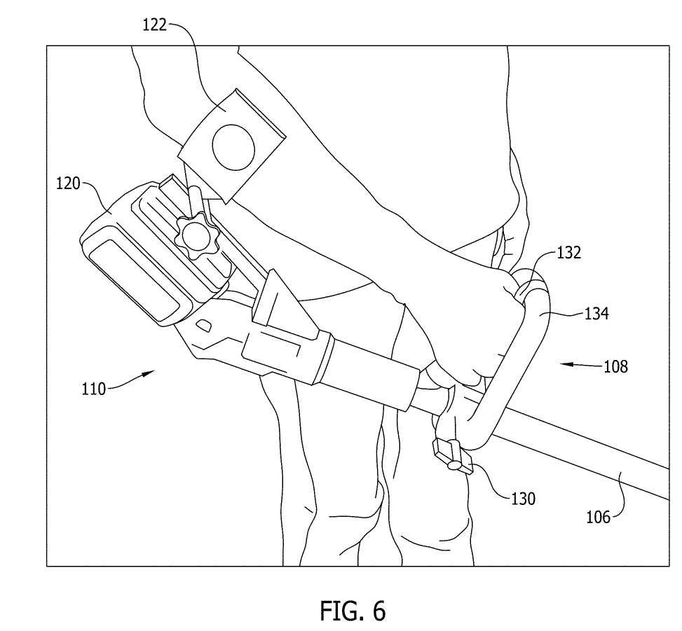

A grip portion 108 may be movably coupled to the upper shaft 106 in some embodiments. For example, the grip portion 108 may include a grip portion clamp 130 (shown in FIGS. 5 and 6) that is releasable to enable the grip portion 108 to move along the upper shaft 106, and then may be clamped down to secure the grip portion 108 in the desired position. Alternatively, any suitable release mechanism may be used.

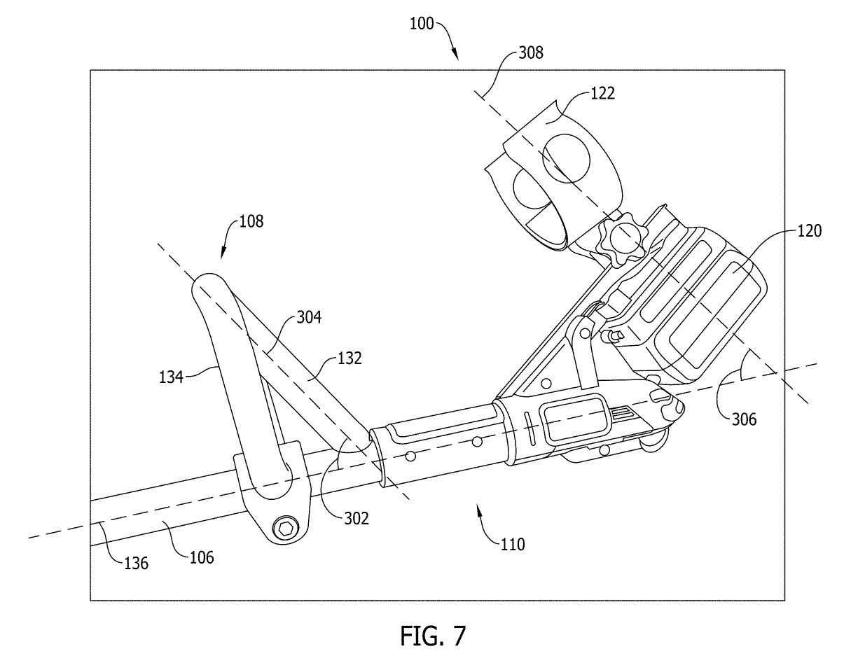

As shown in FIG. 3, the grip portion 108 includes a grip bar 132 and a grip guard 134. The grip bar 132 is a bar that extends outward from the upper shaft 106 to enable the user to hold the grip bar 132 with his or her hand. The grip bar 132 may oriented at an angle (shown more clearly in FIG. 7) with respect to a centerline 136 of the upper shaft 106 and/or lower shaft 104. Thus, by orienting the grip bar 132 at the above-identified angle, the user is enabled to easily and ergonomically hold the grip bar 132 using a hand of the same arm that is used with the arm cuff 122, as described more fully herein. For example, in some embodiments, the angle of the grip bar 132 may be equal to an angle of the arm cuff 122 with respect to the centerline 136 of the upper shaft 106, or the arm cuff 122 may be adjusted to have the same angle as the grip bar 132 as described herein. In other embodiments, the grip bar 132 may be moveable to adjust the angle of the grip bar 132 with respect to the centerline 136 of the upper shaft 106 (e.g., by moving the grip portion clamp 130 toward or away from the arm cuff 122).

The grip guard 134 at least partially encloses the user's hand when the user holds the grip bar 132. Accordingly, the grip guard 134 provides at least partial protection to the user's hand from debris, nearby branches and shrubs, for example, during operation of the string trimmer 100. In some embodiments, the location of the grip portion 108 with respect to the upper shaft 106 is adjustable by the user (e.g., by releasing the grip portion clamp 130, moving the grip portion 108 to a desired location on the upper shaft 106, and re-clamping the grip portion clamp 130 in the desired location). In one embodiment, the grip guard 134 (or another suitable portion of the grip portion 108 such as the grip bar 132) may house a power button or switch and a safety button or bar (neither shown). The power button or switch may be a snap-acting switch with a spring load button. Alternatively, the power button or switch may be any suitable button or switch. The safety button or bar may be a spring loaded bar that can be controlled by either the left hand or the right hand of the user. Alternatively, the safety button or bar may be any suitable button or bar. Thus, the power button and safety button may be conveniently positioned proximate the user's hand when the user is holding the grip bar 132 to enable the user to turn on the string trimmer 100 and disengage the safety button using just one hand.

As shown in FIG. 2, the handle portion 110 includes a removable battery 120 and an arm cuff 122. In one embodiment, the handle portion 110 is about 1 inch in diameter. Alternatively, the handle portion 110 may have any suitable diameter or size. The battery 120 provides power to the motor 112 via a power cable (not shown) extending through the upper shaft 106 and the lower shaft 104. The battery 120 is removably coupled to the handle portion 110 to enable the battery 120 to be replaced if the battery 120 becomes depleted or damaged, for example. In one embodiment, the battery 120 is a lithium ion battery. Alternatively, the battery may use any other suitable battery technology as desired.

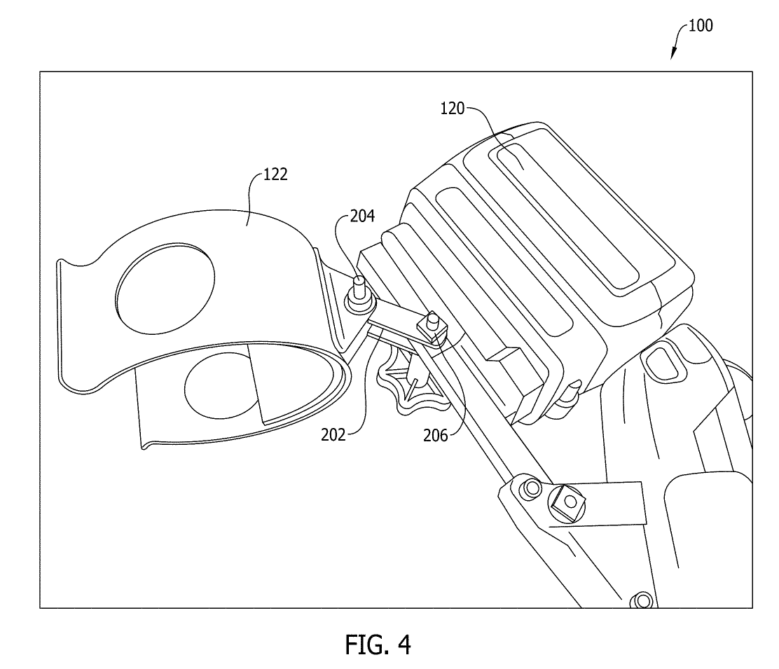

The arm cuff 122 is coupled to the handle portion 110. The arm cuff 122 is sized to receive a portion of a user's arm, such as a forearm of the user. As shown in FIGS. 4-7, in one embodiment, the arm cuff 122 is pivotable about at least one axis to enable the arm cuff 122 to accommodate forearms of different lengths and sizes. For example, a user may pivot the arm cuff 122 to move towards the grip portion 108 to accommodate a forearm of a shorter length, or may pivot the arm cuff 122 away from the grip portion 108 to accommodate a forearm of a longer length. In one embodiment, the arm cuff 122 is hinged to enable the arm cuff 122 to expand or “open up” to receive relatively large forearms, and to contract or “close” to receive relatively small forearms. Alternatively, the arm cuff 122 may be flexible or otherwise adjustable to expand or contract to fit forearms of various sizes. The arm cuff 122 may be formed of aluminum, stainless steel, steel, a plastic material (e.g., acrylonitrile butadiene styrene (ABS) plastic), or any other suitable material that enables the arm cuff 122 to adapt to an individual user's forearm.

As shown in FIG. 2, the battery 120 may include a coupling portion 140 that slidably engages with a receiving portion 142 defined within the handle portion 110. Thus, the user may insert the battery 120 into the handle portion 110 by sliding the coupling portion 140 into the receiving portion 142, and may remove the battery 120 from the handle portion 110 by sliding the coupling portion 140 out of the receiving portion 142.

Accordingly, as described herein, the string trimmer 100 may have an adjustable length due to the relative adjustment of the lower shaft 104 and the upper shaft 106 with respect to each other. The string trimmer 100 may also have an adjustable location for the grip portion 108 by virtue of the grip portion clamp 130, and may have an adjustable size and pivot location of the arm cuff 122. These various adjustable components of the string trimmer 100 provide a significant number of options for user to select to customize the string trimmer 100 to the user's specific desires, preferences, and arm sizes, for example. In addition, the grip portion and the arm cuff 122 enable the user to operate the string trimmer 100 using only one hand and arm. For example, the user's hand may hold the grip bar 132 to provide the control necessary to move the string trimmer 100 into desired positions to trim vegetation, while the user's forearm (of the same arm) is secured within the arm cuff 122 to provide stability when moving the string trimmer 100 into the desired positions. The arm cuff 122 may also transfer a significant amount of the weight of the string trimmer 100 to the user's arm, rather than to the user's hand at the grip portion 108, to minimize fatigue of the user's hand. In addition, the adjustable length of the lower shaft 104 and the upper shaft 106 as well as the adjustable location of the grip portion 108 and the arm cuff 122 enable the user to adjust a center of gravity of the string trimmer 100 to a desired position. For example, the center of gravity may be aligned with the grip portion 108 such that the user is able to easily pivot or move the string trimmer 100 using the grip portion 108.

FIGS. 4-7 are various views of the string trimmer 100 showing the arm cuff 122 in different pivot positions. Specifically, FIG. 4 is a perspective view of the arm cuff 122. FIG. 5 is a side view of the handle portion 110 and grip portion 108 of the string trimmer 100 during operation by a first user. FIG. 6 is a side view of the handle portion 110 and grip portion 108 of the string trimmer 100 during operation by a second user. FIG. 7 is a side view of the handle portion 110 and grip portion 108 of the string trimmer 100.

Referring to FIG. 5, the arm cuff 122 is coupled to the handle portion 110 via a linkage arm 202. The linkage arm 202 is coupled to the arm cuff 122 at a first, or upper pivot point 204 and is coupled to the handle portion 110 at a second, or lower pivot point 206. Each pivot point may be secured by a knob or other mechanism that may be tightened to enable pivoting, or loosened to disable pivoting. Thus, the arm cuff 122 and the linkage arm 202 are pivotable about two axis: a first axis defined through the upper pivot point 204 and a second axis defined through the lower pivot point 206.

In the example illustrated in FIG. 5, a first user has pivoted and positioned the arm cuff 122 in a first position relatively close to the grip portion 108 to accommodate the first user's relatively smaller forearm. In the example illustrated in FIG. 6, a second user has pivoted and positioned the arm cuff 122 in a second position relatively distant from the grip portion 108 to accommodate the second user's relatively larger forearm.

Referring to FIG. 7, the arm cuff 122 is pivoted and positioned in a third, or neutral position with respect to the grip portion 108. In this neutral position, an angle 302 of a centerline of 304 the grip handle 132 with respect to the centerline 136 of the upper shaft 106 is substantially equal to an angle 306 of a centerline 308 of the arm cuff 122 with respect to the centerline of the upper shaft 106. In a specific embodiment, the angle 306 of the centerline 308 of the arm cuff 122 is about 20 degrees with respect to the centerline of the upper shaft 106. In another embodiment, the angle of the linkage arm 202 is about 20 degrees with respect to the centerline of the upper shaft 106. Alternatively, the angle 306 of the centerline 308 and/or the angle of the linkage arm 202 may be any suitable angle. Accordingly, the alignment of the arm cuff 122 with the grip handle 132 may further reduce strain on the user's hand and/or arm during operation of the string trimmer 100.

In one embodiment, the handle portion 110 is slidable with respect to the upper shaft 106 such that a distance between the handle portion 110 and the grip portion 108 is adjustable. In a specific embodiment, the distance may be adjusted from about 4 inches to about 12 inches. Alternatively, the distance may be adjusted in any suitable amount. In one embodiment, the handle portion 110 may include a clamp or other coupling mechanism (not shown) that is releasable to enable the handle portion 110 to move along the upper shaft 106 and/or pivot about the upper shaft 106, and then may be clamped down to secure the handle portion 110 in the desired position. Alternatively, any suitable release or coupling mechanism may be used.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A string trimmer, comprising:
a handle portion comprising:
an arm cuff for securing a portion of an arm of an operator to the handle portion;
a grip portion enabling the operator to hold the grip portion using a hand of the same arm during operation of the string trimmer;
a first shaft coupled to the handle portion;
a second shaft at least partially slidable into the first shaft;
a head portion coupled to the second shaft, the head portion comprising:
a hub comprising a cutting tool; and
a motor configured to rotate the hub.

2. The string trimmer of claim 1, wherein the arm cuff is pivotable about at least one axis.

3. The string trimmer of claim 1, further comprising a linkage arm coupled to the arm cuff and a portion of the handle portion, wherein the linkage arm is pivotable about at least one axis.

4. The string trimmer of claim 1, wherein the grip portion is movable along the first shaft.

5. The string trimmer of claim 1, wherein the grip portion includes an attachment mechanism that enables the handle to be secured to a plurality of locations along the first shaft.

6. The string trimmer of claim 1, wherein the arm cuff is hinged to enable it to be secured to arms of different sizes.

7. The string trimmer of claim 1, wherein the second shaft is enabled to be moved inside the first shaft a user-controlled amount to enable the length of the string trimmer to be adjusted.

8. The string trimmer of claim 1, further comprising a coupling member that enables the first shaft and the second shaft to be releasably coupled to each other.

9. The string trimmer of claim 1, wherein the grip portion comprises a grip bar and a grip guard, wherein the grip guard at least partially encloses the operator's hand when the operator holds the grip bar.

10. The string trimmer of claim 1, further comprising a battery that is removably coupled to the handle portion for providing power to the motor.
